(19) United States
(12) Patent Application Publication
(10) Pub. No.: US 2008/0307969 A1
(43) Pub. Date: Dec. 18, 2008

(54) Method for Cleaning Exhaust Gases Containing Nitrous Gases

(75) Inventor: Martin Schottler, Stuttgart (DE)

Correspondence Address: GUDRUN E. HUCKETT DRAUDT, SCHUBERTSTR. 15A, WUPPERTAL, 42289, DE

(73) Assignee: M+W ZANDER FACILITY ENGINEERING LIMITED, Singapore (SG)

(21) Appl. No.: 11/939,566

(22) Filed: Nov. 14, 2007

(30) Foreign Application Priority Data
Nov. 16, 2006 (DE) 10 2006 054 972.4

(51) Int. Cl. B01D 47/02; B01D 53/14

(52) U.S. Cl. 95/226

(57) ABSTRACT

In a method for cleaning exhaust gases containing nitrous gases, the exhaust gas is passed through a scrubbing solution that contains a reducing component with which the nitrous gases are reduced to nitrogen wherein as the reducing component ammonium ions (NH₄⁺) are used. The scrubbing solution comprises water and ammonium sulfate ((NH₄)₂SO₄). Alternatively, the reducing component is ammonia gas.

### BACKGROUND OF THE INVENTION

The invention concerns a method for cleaning exhaust gases containing nitrous gases in which method the exhaust gas is passed through a scrubbing solution that contains a reducing component with which the nitrous gas is reduced to nitrogen. For removing nitrous gases from exhaust gases, oxidizing, neutralizing, and reducing methods are known. Oxidizing methods utilize H₂O₂ or HNO₃ as oxidizing media. H₂O₂ is used in alkaline scrubbing solutions and oxidizes NO to NO₂ that is dissolved and neutralized with OH⁻ ions:

NO+H₂O₂->NO₂+H₂O.

This reaction happens primarily in the gas phase because NO is hardly water-soluble. NO₂ on the other hand dissolves easily in water and disproportionates in water:

2NO₂(aq)+H₂O->NO₂⁻+NO₃⁻+2H⁺

2H⁺+2OH⁻->2H₂O.

By autooxidation of NO₂— that is generated in addition to NO₃—, there is also NO generated again in accordance with the following equation:

3NO₂⁻+2H⁺->2NO+NO₃⁻+H₂O.

NO escapes from the solution because it is not water-soluble. The dissolution of a portion of NO₂ in water therefore releases 30% of the nitrogen as NO. This requires renewed oxidation of NO so that an extended total residence time results. Moreover, the method is made expensive by utilizing H₂O₂. As a result of the long residence times within a magnitude of up to 20 seconds, the cleaning process is very time-consuming. Moreover, large apparatus are required.

It is also known in connection with oxidizing methods to produce HNO₃ from NOₓ exhaust gases by absorption with oxidation in nitric acid solutions. As a result of the residual vapor pressure of NOₓ above nitric acid solutions, high absorption rates are not possible. Moreover, a second stage for limiting the acid emissions is required. Also, not all users have the goal or the possibility of producing or utilizing nitric acid solutions.

In the case of a simple neutralization the NO that is oxidizable in the available residence time is oxidized by reaction with oxygen from the air to NO₂ and absorbed in alkaline solution together with the portion of the nitrous gases NOₓ that is present as NO₂:

2NO₂(aq)+H₂O->NO₂⁻+NO₃⁻+2H⁺

2H⁺+2OH⁻->2H₂O.

A disadvantage of this neutralization method is that in case of a change of the pH value the nitrous gases are released again. By means of the above mentioned autooxidation of the nitrite NO₃— the total efficiency is moreover limited.

The reducing methods can be carried out in the gas phase or in liquid phase. When performing the method in the gas phase, selective (SCR—selective catalytic reduction) and non-selective (NSCR—non-selective catalytic reduction) catalysts are utilized. For selective catalysts the cleaning process is as follows:

3NO+2NH₃->2.5N₂+3H₂O

3NO₂+4NH₃->3.5N₂+6H₂O.

When using non-selective catalysts the reduction is carried out with H₂, CH₄ or CO. This method is used in connection with flue gases because increased temperatures are required.

It is also possible to reduce the nitrous gases NOₓ in liquid phase. For this purpose, chemicals such as sulfide, sulfite, hydrogen sulfite (also as a gaseous addition of SO₂) or thiosulfate are used.

### SUMMARY OF THE INVENTION

The invention has the object to develop the method of the aforementioned kind in such a way that nitrous gases can be removed inexpensively in a reduced amount of time but still reliably from the exhaust gases.

This object is solved for the method of the aforementioned kind in accordance with the present invention in that as a component for reducing the nitrous gases (NOₓ) ammonium ions (NH₄⁻) are used.

In the method according to the invention the ammonium ions develop a scrubbing effect in acidic solution. The nitrous gases are reduced to nitrogen. The agents used for generating ammonium ions, for example, (NH₄)₂SO₄ or ammonia gas, are inexpensive components so that the cleaning method can be performed accordingly in an inexpensive way. Often, these components are even produced as waste products in factories so that they can be utilized advantageously for the method according to the invention.

### BRIEF DESCRIPTION OF THE DRAWINGS

Further features of the invention result from the additional claims, the description, and the drawing.

The invention will be explained in more detail in connection with two embodiments illustrated in the drawings. It is shown in:

FIG. 1 in a schematic illustration a first embodiment of the device for performing the method according to the invention;

FIG. 2 in a schematic illustration a second embodiment of the device for performing the method according to the invention.

### DESCRIPTION OF THE PREFERRED EMBODIMENTS

Nitrous gases in exhaust gases represent pollutants that are not only detrimental to the environment but are also a health hazard. Nitrous gases are generally a mixture of NO and NO₂. The nitrous gases can be reliably removed from the exhaust gases by means of a solution containing ammonium salts. For this purpose, the exhaust gas with the nitrous gases is passed through the solution wherein the scrubbing process occurs in accordance with the following equation:

3NO₂+4NH₄⁺->3.5N₂+6H₂O+4H⁺.

As a reaction product of this scrubbing process nitrogen is thus produced. Because the comproportionation is carried out in the acidic range, additional acid is produced according to the equation. However, no other waste products are produced that would have to be disposed of.

The scrubbing process can be carried out in conventional contact apparatus that are used for gas scrubbing. Examples of such contact apparatus are scrubbing columns with packed bed or fixed packing, bubble columns and the like.

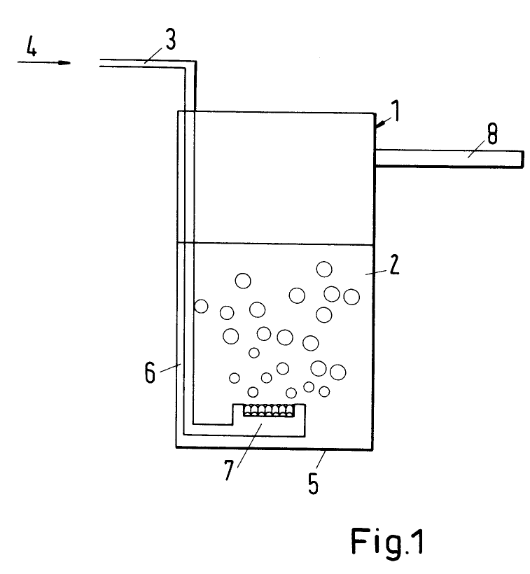

FIG. 1 shows in an exemplary fashion such a scrubber with a container 1 in which the scrubbing liquid 2 is contained. At least one conduit 3 through which the exhaust gas 4 containing the nitrous gases are supplied opens into the container 1. The conduit 3 extends to the bottom 5 of the container 1. The conduit 3 extends advantageously at minimal spacing along the inner side of the wall 6 of the container and has a distribution nozzle 7 arranged approximately centrally relative to the bottom 5 from which nozzle the exhaust gas to be cleaned exits upwardly into the scrubbing liquid 2. The nitrous gases contained in the exhaust gas 4 are absorbed in accordance with the above described equation in the scrubbing liquid 2 and are converted by the reaction according to above mentioned equation to nitrogen. The cleaned exhaust gas flows through at least one outlet conduit 8 to the exterior which conduit is arranged above the scrubbing liquid level near the upper edge of the container 1.

The scrubbing liquid 2 is comprised of water in which ammonium salts, for example, ammonium sulfate or ammonium hydrogen sulfate, are dissolved. It is also possible to dissolve ammonia in water. Per kilogram of NO₂ gas 0.4 kg of ammonia is required. When ammonium hydrogen sulfate NH₄HSO₄ is used, 3.34 kg of NH₄HSO₄ in 40 liters of water are used per 1 kg of NO₂. With such a scrubbing liquid at least 100 m³ of exhaust gas with nitrous gases NOₓ in a concentration of 8,000 mg/m³ can be cleaned. Depending on the concentration of the nitrous gases in the gas 4, the aforementioned scrubbing solution quantity also suffices for cleaning larger volumes. For example, for a concentration of 800 mg/m³ 1,000 m³ exhaust gas can be cleaned. When the replacement of scrubbing liquid is carried out continuously, for an exhaust gas flow rate of e.g. 5,000 m³/h at a concentration of 800 mg/m³ it is necessary to supply 13.4 kg NaHSO₄ in 160 liters of water and the equivalent amount of wastewater must be removed.

When the concentrations of nitrous gases in the exhaust gas 4 are higher, a larger quantity of scrubbing liquid and a corresponding addition of ammonium salts are needed. In a typical case, for 3,000 m³/h exhaust gas that contains 10 kg NO₂/h as nitrous gas, 33 kg/h NH₄HSO₄ in 400 I/h water would be required.

Metering of the gaseous or liquid ammonia or ammonium salt is carried out advantageously by measuring the NO₂ concentration in the cleaned exhaust gas flowing out through outlet conduit 8. When the concentration in the cleaned exhaust gas surpasses a permissible or preset value, ammonium salt solution or ammonia gas is added. This is done advantageously automatically so that a continuous cleaning of the exhaust gases is possible without problem.

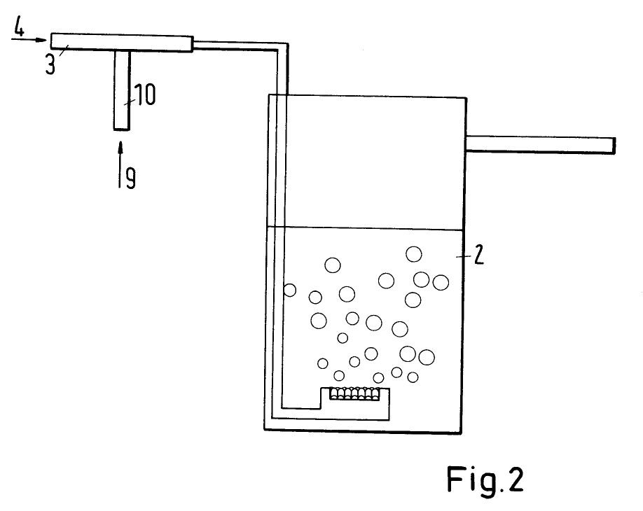

FIG. 2 shows the possibility of adding ammonia gas 9 to the exhaust gas 4 before the exhaust gas enters the scrubbing solution 2. The ammonia gas 9 is supplied by conduit 10 that opens into the exhaust gas conduit 3. Such an embodiment is advantageous when, for example, the ammonia gas is an additional exhaust gas that is produced in the same factory as the exhaust gas 4 containing nitrous gases. It is then possible in this factory to employ the exhaust gas in the form of ammonia gas for removing the nitrous gases from the exhaust gas 4.

The described scrubbing liquid 2 is often produced in large factories as waste solution. As a result of its secondary use as a scrubbing solution, the scrubbing solution provides an inexpensive alternative to the conventional cleaning processes.

The described scrubbing process for removing the nitrous gases from exhaust gases is advantageously utilized in the production of solar cells, in particular, photovoltaic cells. In such solar cell factories usually 50 to 80% reduction of the NOₓ emissions is required. These reductions can be realized reliably with the described method. In comparisons to neutralization scrubbers the described method is significantly more powerful and more effective.

In order for the nitrous gases to be removed reliably from the exhaust gases 4, in the container 1 a sufficient liquid volume is present. The exhaust gas 4 to be cleaned is introduced at such a pressure and thus at such a speed into the scrubbing liquid 2 that a gas residence time sufficient for removal of the nitrous gases is ensured. This ensures that NO contained in the exhaust gas is oxidized to NO₂:

NO+0.5O₂->NO₂.

This reaction occurs spontaneously in the gas phase and must not be initiated in a special way.

The scrubbing process can be carried out in a temperature range of approximately 5° C. to approximately 40° C. At higher temperatures the cleaning of the exhaust gases is more effective than at lower temperatures. Advantageously, the scrubbing liquid 2 circulates during the scrubbing process in order to achieve an optimal cleaning action of the exhaust gas 4. For effecting circulation, the scrubbing liquid 2 is introduced at a pressure of up to approximately 3 bar into the container 1. The concentration of ammonium salts can be up to approximately 5 mol % NH₄⁺/I solution.

The exhaust gas to be cleaned can have a temperature of approximately 0° C. to approximately 200° C. In this connection, the exhaust gas can be introduced at a pressure of up to approximately 3 bar into the scrubbing liquid 2. The exhaust gas 4 can contain up to approximately 1,000 mg/m³ NOₓ gas. The water utilized for the scrubbing liquid 2 is advantageously neutral. As a result of the cleaning process, the liquid becomes acidic, i.e., the pH value drops below 7. As a result of the reaction of ammonium salts with the nitrous gases in the exhaust gas 4 acids are formed that cause the pH value of the water to drop. A neutralization is not required for maintaining the scrubbing function.

It has been found that per kg of NO₂ approximately 0.4 kg ammonia are required.

The scrubbing liquid utilized for cleaning the exhaust gases 4 is inexpensive, in particular, because it is present as a waste solution depending on the type of industrial facility. The employed scrubbing apparatus can be of a simple construction.

The described method is also very well suited for cleaning relatively small volumes of air. Such minimal exhaust gas quantities occur, for example, in the case of wet benches for etching silicon. The method can be utilized excellently for such applications.

When using (NH₄)₂SO₄ solutions, the cleaning activity will increase at pH neutral and with increasing cleaning duration. This is inter alia the result of the scrubbing liquid 2 becoming increasingly acidic with increasing cleaning duration because the NO₂ produced in the cleaning process causes a shift of the pH value to lower values. In the acidic range, the reaction rate of the scrubbing process will increase.

Because for the scrubbing process a satisfactory liquid volume must be present, as a scrubbing device advantageously an apparatus of the type of a bubble column is used. Such apparatus are known and will therefore not be explained in more detail with regard to their construction.

It is also possible to employ an air washer with packing material, a so-called scrubber, as a scrubbing device. Such air washers are characterized by their small size so that they can be utilized advantageously where large exhaust gas volumes are to be expected.

The use of ammonium sulfate has the advantage that it is inexpensive and can be purchased cheaper than H₂O₂ that has been used up to now. A further advantage of using ammonium sulfate resides in that it is produced as wastewater of ammonium scrubbers and can be utilized as a scrubbing liquid for removing nitrous gases from exhaust gases.

What is claimed is:

1.-12. (canceled)

13. A method for cleaning exhaust gases containing nitrous gases, the method comprising the steps of:
passing the exhaust gas through a scrubbing solution that contains a reducing component with which the nitrous gases are reduced to nitrogen wherein as the reducing component ammonium ions (NH₄⁺) are used.

14. The method according to claim 13, wherein the scrubbing solution comprises water and ammonium sulfate ((NH₄)₂SO₄).

15. The method according to claim 13, wherein the reducing component is ammonia gas.

16. The method according to claim 15, comprising the step of introducing the ammonia gas into the exhaust gas before the exhaust gas is introduced into the scrubbing solution.

17. The method according to claim 13, wherein the scrubbing process is carried out in accordance with the following equation:
3NO₂+4NH₄⁺->3.5N₂+6H₂O+4H⁺.

18. The method according to claim 13, where the scrubbing solution has a temperature in a range of approximately 5° C. to approximately 40° C.

19. The method according to claim 13, wherein the scrubbing solution contains approximately 5 mol % ammonium ions (NH₄⁺) per liter.

20. The method according to claim 13, further comprising the step of circulating the scrubbing solution.

21. The method according to claim 13, further comprising the step of supplying the exhaust gas in a temperature range between approximately 0° C. and approximately 200° C. to the scrubbing solution.

22. The method according to claim 13, further comprising the step of supplying the exhaust gas at a pressure between approximately 0 bar and approximately 3 bar.

23. The method according to claim 13, wherein the exhaust gas contains up to approximately 10,000 mg/m³ nitrous gases (NOₓ).

14. The method according to claim 13, performed continuously.
